(19) United States
(12) Patent Application Publication
(10) Pub. No.: US 2025/0153083 A1
(43) Pub. Date: May 15, 2025

(54) Air Cleaner System and Method of Use

(71) Applicant: MMLJ, INC, HOUSTON, TX (US)

(72) Inventors: Benjamin LeCompte, Houston, TX (US); Blain LeCompte, Houston, TX (US)

(21) Appl. No.: 18/948,454

(22) Filed: Nov. 14, 2024

Related U.S. Application Data
(60) Provisional application No. 63/598,834, filed on Nov. 14, 2023.

(51) Int. Cl. B01D 46/00

(52) U.S. Cl. CPC B01D 46/003; B01D 2221/14; B01D 2273/30

(57) ABSTRACT

An air cleaner system for filtering an input air into a treated air output is disclosed. Comprising an air dryer assembly configured to cool and condense moisture from incoming compressed air. A fan configured to facilitate airflow through the air dryer assembly. An air input assembly configured to receive external air. A filter assembly comprising a moisture separator and a coalescing filter, configured to remove contaminants and moisture from the compressed air. An air output assembly configured to provide treated air to a target equipment. A power supply configured to operate the air cleaner system using either AC power or a battery. A controller configured to monitor conditions within the air cleaner system and adjust the performance of the air dryer assembly and the fan. An air dryer assembly configured to cool and condense moisture from incoming compressed air. A fan configured to facilitate airflow through the air dryer assembly.

### CROSS-REFERENCE TO RELATED APPLICATIONS

This application claims benefit to U.S. provisional application No. 63/598,834 filed 2023 Nov. 14.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

The present invention relates to the field of air treatment systems, particularly those designed for industrial applications. The invention focuses on improving heat dissipation and humidity control of input air used in industrial equipment. In industrial settings, the quality of input air is crucial, especially for equipment that is sensitive to moisture and particulate contaminants. Traditional air treatment systems often struggle to efficiently manage both the cleanliness and humidity of air, especially in compact setups. For instance, moisture presence in smaller, miniaturized equipment can lead to significant operational issues, such as valves getting stuck due to a single drop of water in the triggering mechanism. This is a common problem in humid regions like the Gulf Coast of the United States, where air must be treated for moisture before being used in sensitive equipment.

Existing solutions, like desiccant systems that use gels to extract moisture from airflow, are often inadequate for scenarios requiring large volumes of air at specific pressures. These systems can be cumbersome, less effective in high-flow scenarios, and may not offer the required flexibility in pressure adjustment. Furthermore, the need for a portable, versatile system that can operate in various field conditions, either through battery or grid power (AC/DC), is increasingly evident.

There is a need for a compact, efficient air cooler and drier assembly that can effectively eliminate moisture and contaminants from compressed air while maintaining a high level of operational efficiency. The present invention aims to address these challenges by providing a system capable of delivering clean, dry air at a range of pressures suitable for both large and small industrial equipment. Key objectives include ensuring the provision of clean, dry air, especially for miniaturized equipment where moisture is a critical concern; offering a flexible pressure range to cater to different industrial needs; replacing traditional desiccant systems with a more efficient, portable solution; and incorporating a water reservoir for collecting moisture extracted from the air, enhancing the system's efficiency in moisture control. The present invention is designed to function as a standalone unit, easy to deploy and use in the field, and suitable for a variety of industrial applications. The incorporation of multiple filters, including an optional lubricant filter and a coal-free filter, ensures the highest quality of output air, free from contaminants and moisture, ultimately improving operational efficiency and extending the lifespan of industrial equipment.

No prior art is known to the applicant.

### BRIEF SUMMARY OF THE INVENTION

An air cleaner system 100 for filtering an input air 202 into a treated air output 122, air cleaner system 100 comprises an air input assembly 106, an air dryer assembly 102, a fan 104, a mini flex assembly 114, a filter assembly 116 and an air output assembly 118, the fan 104 configured to facilitate airflow through said air dryer assembly 102, the filter assembly 116 is configured to remove contaminants and moisture from said compressed air, the air input assembly 106 configured to receive said input air 202, the air output assembly 118 configured to provide treated air to a target equipment 120.

An air cleaner system 100 for filtering the input air 202 into the treated air output 122, said air cleaner system 100 comprises the air input assembly 106, the air dryer assembly 102, the fan 104, the mini flex assembly 114, the filter assembly 116 and the air output assembly 118, the fan 104 configured to facilitate airflow through said air dryer assembly 102, the filter assembly 116 is configured to remove contaminants and moisture from said compressed air, the air input assembly 106 configured to receive said input air 202, the air output assembly 118 configured to provide treated air to the target equipment 120, said air cleaner system 100 further comprises a controller 126 configured to monitor conditions within said air cleaner system 100 and adjust the performance of said air dryer assembly 102 and said fan 104, said air cleaner system 100 can further comprise device application 204 configured to generate said sensor data of ruse by controller 126 in controlling air cleaner system 100, said controller 126 is further configured to receive sensor data related to airflow, temperature, and moisture levels and to dynamically adjust the operation of said air dryer assembly 102 and said fan 104 based on said sensor data.

A method of use 1000 of the air cleaner system 100 for cleaning compressed air is disclosed. Comprising receiving the input air 202 through the air input assembly 106, cooling and condensing moisture from said input air 202 using the air dryer assembly 102, facilitating airflow through said air dryer assembly 102 using the fan 104, passing said compressed air through the filter assembly 116 comprising a moisture separator and a coalescing filter to remove remaining moisture and contaminants, providing treated air through the air output assembly 118 to the target equipment 120, wherein, said air cleaner system 100 comprises the air input assembly 106, the air dryer assembly 102, the fan 104, the mini flex assembly 114, the filter assembly 116 and the air output assembly 118, the fan 104 configured to facilitate airflow through said air dryer assembly 102, the filter assembly 116 is configured to remove contaminants and moisture from said compressed air, the air input assembly 106 configured to receive said input air 202, the air output assembly 118 configured to provide treated air to the target equipment 120.

### BRIEF DESCRIPTION OF THE SEVERAL VIEWS OF THE DRAWING

FIG. 1 illustrates an elevated front view of said air cleaner system 100.

FIG. 2 illustrates a block diagram 200 of said air cleaner system 100.

FIG. 3 illustrates an elevated top view of said air cleaner system 100.

FIG. 4 illustrates an elevated front view of said air cleaner system 100, focusing on the frontal components like said air dryer assembly 102 and said fan 104, providing insight into the system's frontal profile and airflow dynamics.

FIG. 5 illustrates an elevated side view of said air cleaner system 100, showing the alignment and interaction of various components like said air dryer assembly 102, said fan 104, and said mini flex assembly 114.

FIG. 6 illustrates an elevated rear view of said air cleaner system 100 with a detailed callout of said air output assembly 118 and said air input assembly 106.

FIG. 7 illustrates a perspective overview of said air dryer assembly 102.

FIG. 8 illustrates an elevated front view of said air dryer assembly 102.

FIGS. 9A, 9B, and 9C illustrate an elevated side view, front view, and cross-sectional side view of said mini flex assembly 114.

FIG. 10 comprises a method of use 1000 of said air cleaner system 100.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

The present invention is described in detail with reference to the accompanying figures, which illustrate specific embodiments of an air cleaner system 100. It is to be understood that the invention is not limited to the precise arrangements shown in the figures but may be embodied in various forms.

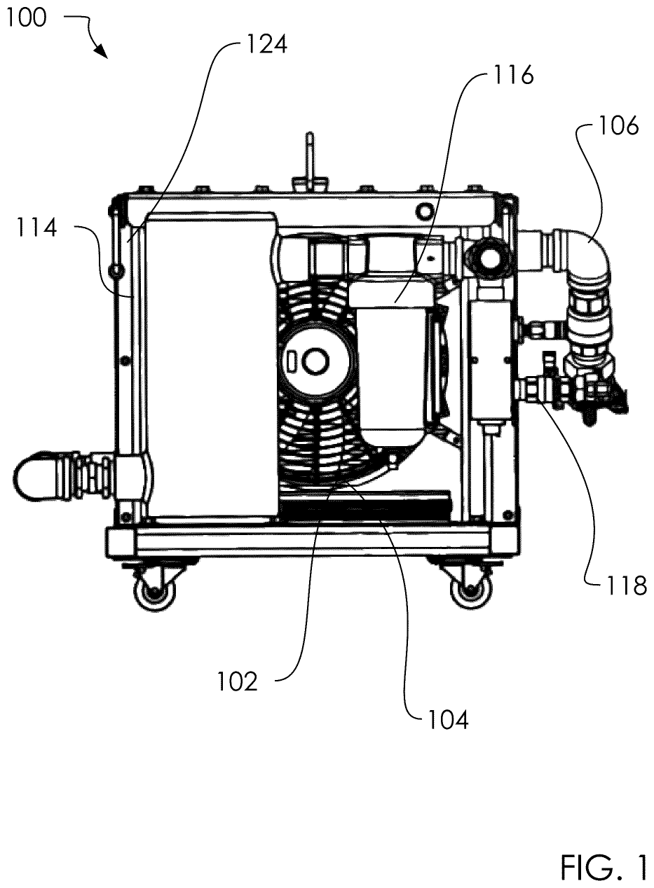

FIG. 1 illustrates an elevated front view of said air cleaner system 100.

In one embodiment, said air cleaner system 100 can comprise an air dryer assembly 102, a fan 104, an air input assembly 106, a power supply 108, a power switch 110, a water reservoir 112, a mini flex assembly 114, a filter assembly 116, an air output assembly 118, a frame assembly 124, and a controller 126.

In one embodiment, said air output assembly 118 can comprise a quick connect system configured to selectively attach and detach from a target equipment 120. Said air cleaner system 100 can be configured to connect to and provide a treated air output 122 for said target equipment 120.

Said air dryer assembly 102, which can be configured for air processing, is integral to the system's airflow management. Said fan 104 is also shown, along with said air input assembly 106, which is the primary entry point for unprocessed air.

In one embodiment, said power switch 110 can be configured to provide power to said air cleaner system 100 where grid power is not provided. For example, where said target equipment 120 is in the field and clean air is inaccessible, said power switch 110 can selectively turn said air cleaner system 100 on and off, as is known in the art.

Said air dryer assembly 102 plays a crucial role in moisture removal from the incoming air, employing a stainless steel wire mesh for cooling and condensing air moisture.

Said fan 104 is responsible for the movement of air through the system, ensuring efficient airflow through various components.

Said air input assembly 106 acts as the entry point for external air, channeling it into the system for processing.

Said power supply 108 and said power switch 110 provide and control the power to the system, allowing it to operate on both battery and grid power.

Said water reservoir 112 collects and stores water extracted from the air, thus maintaining the dryness of the output air.

Said mini flex assembly 114 offers additional filtration and flexibility in handling air within the system.

Said filter assembly 116 comprises multiple filters, including a coal-free filter and an optional lubricant filter, to ensure the air is free from contaminants and moisture.

Said air output assembly 118 provides a convenient interface for connecting the system to various industrial tools and equipment.

Said target equipment 120 represents the equipment or machinery that utilizes the clean, dry air provided by the system.

Said air cleaner system 100 comprises a compact air cooler/drier assembly mounted on a cart, measuring approximately 20 inches wide by 31 inches long by 22 inches high, and weighing under 100 pounds. Said air cleaner system 100 is easily maneuverable with handles and caster wheel mounts, and can be powered either by plugging into an AC wall outlet or by directly connecting to a 12V battery, providing flexibility in its operation.

Said air cleaner system 100 is configured to cool and dry compressed air, ensuring high-quality air suitable for tools requiring compressed air. The compressed air enters said air cleaner system 100 and passes through said fan 104 and a radiator, cooling the supplied air. Said cooled air then travels through a moisture separator, which removes moisture from the air, followed by said filter assembly 116, where remaining moisture agglomerates in a coalescing filter for easy removal. The resulting treated air output is dry and cooled, suitable for use by said target equipment 120.

The benefits of said air cleaner system 100 include increased productivity and quality for various applications, such as paint systems (e.g., piston pump airless paint guns), safety equipment (e.g., forced air blast helmets), gas pipeline installation and maintenance, and light-duty sandblasters. Said air cleaner system 100 can be applied to any system requiring high-quality compressed air. Various configurations of the assembly are possible, including different placements of said fan 104 and said moisture separator, as well as the use of diverse materials such as carbon steel, aluminum, stainless steel, high-grade plastic, or injection-molded components. Said air cleaner system 100 can be powered by AC power, a 12V DC converter, or battery operation, providing versatility in power options.

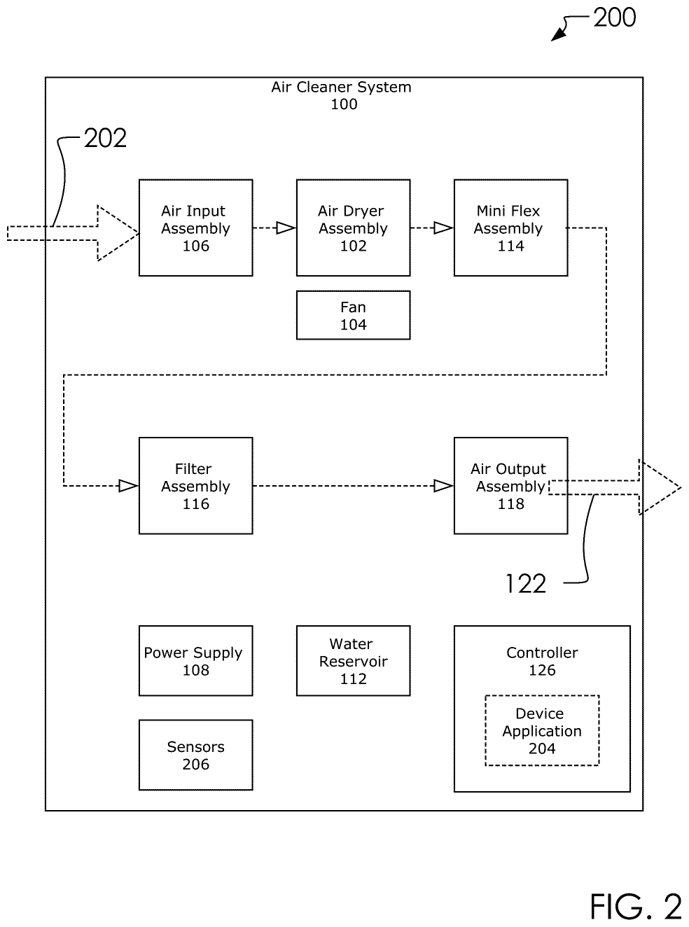

FIG. 2 illustrates a block diagram 200 of said air cleaner system 100.

As shown, an input air 202 can enter said air cleaner system 100 through said air input assembly 106, be cooled and dried in said air dryer assembly 102, further filtered in said mini flex assembly 114 and said filter assembly 116, and exit said air cleaner system 100 through said air output assembly 118 as said treated air output 122.

In one embodiment, said controller 126 can monitor conditions within said air cleaner system 100 and modify the functionality of said air dryer assembly 102 and said fan 104 according to a device application 204 stored within said controller 126.

Further illustrated are the connections and relationships between the various components of said air cleaner system 100. For example, in one embodiment said controller 126 is configured to monitor the conditions of said air dryer assembly 102, said fan 104, and said mini flex assembly 114. The controller 126 can receive sensor data related to airflow, temperature, and moisture levels, and dynamically adjust the performance of said air dryer assembly 102 and said fan 104 based on the requirements of said device application 204. This can ensure optimal functionality and efficiency in producing treated air output.

Said power supply 108 can interface with said controller 126 to regulate power distribution among the components, enabling consistent and reliable operation. The airflow path, as depicted, demonstrates how compressed air is sequentially processed through each stage, ensuring that the output air meets the desired quality for said target equipment 120.

Said air cleaner system 100 can further comprise one or more sensors 206 configured to generate said sensor data of ruse by controller 126 in controlling air cleaner system 100.

In one embodiment, input air 202 can comprise air from an air compressor. These are notorious for providing moisture rich airflows which may not be useful for target equipment 120.

One benefit of air cleaner system 100 in practice is the reduction of a dewpoint of air between input air 202 and treated air output 122.

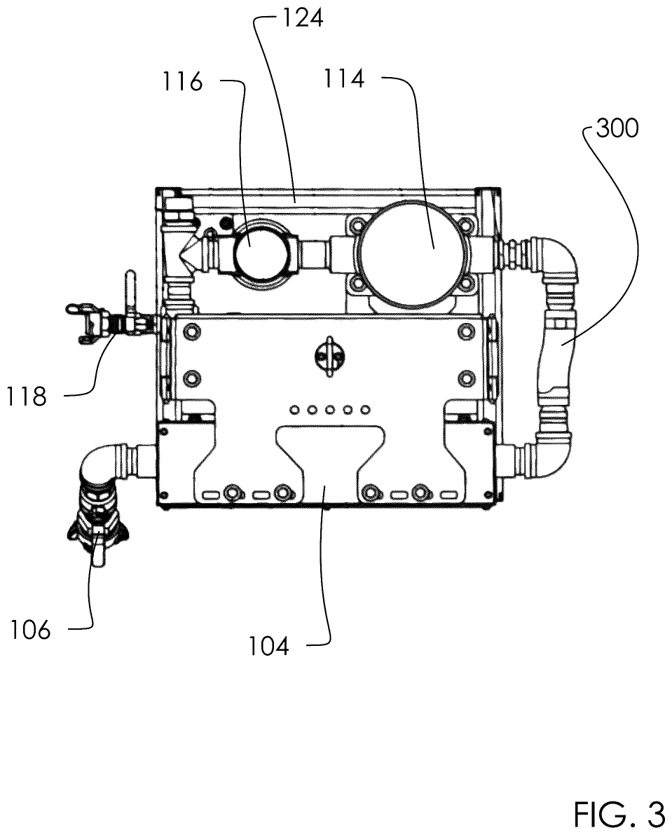

FIG. 3 illustrates an elevated top view of said air cleaner system 100.

In one embodiment, said fan 104 and said mini flex assembly 114 can be connected to one another using a hose assembly 300.

Said air cleaner system 100 illustrates the flow of air starting from said air input assembly 106, where external air or input air is drawn into the system. The air is then processed sequentially through said air dryer assembly 102, said fan 104, and said mini flex assembly 114. Finally, the processed air exits through said air output assembly 118 as treated air, which is ready for use by said target equipment 120. This figure emphasizes the path of air through each major component, showcasing how the system ensures that the air is cooled, dried, and filtered effectively before it reaches the output stage.

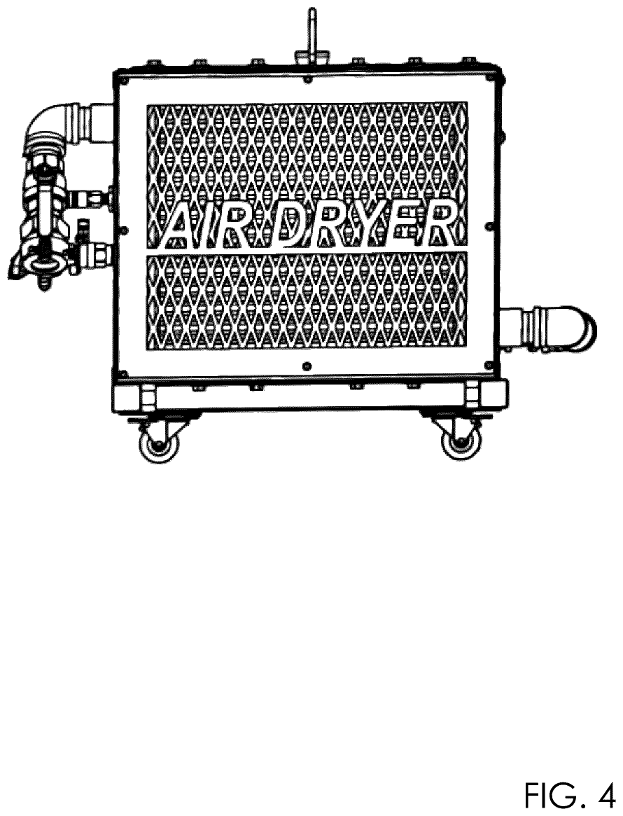

FIG. 4 illustrates an elevated front view of said air cleaner system 100, focusing on the frontal components like said air dryer assembly 102 and said fan 104, providing insight into the system's frontal profile and airflow dynamics.

The arrangement of these frontal components, including said air dryer assembly 102 and said fan 104, is designed to maximize airflow efficiency and cooling capacity. Specifically, the placement of said air dryer assembly 102 in close proximity to said fan 104 allows for optimal airflow through the cooling mechanism, thereby enhancing the drying process. This strategic alignment not only improves the cooling rate but also ensures that the components are easily accessible for maintenance, contributing to the overall ease of servicing the system.

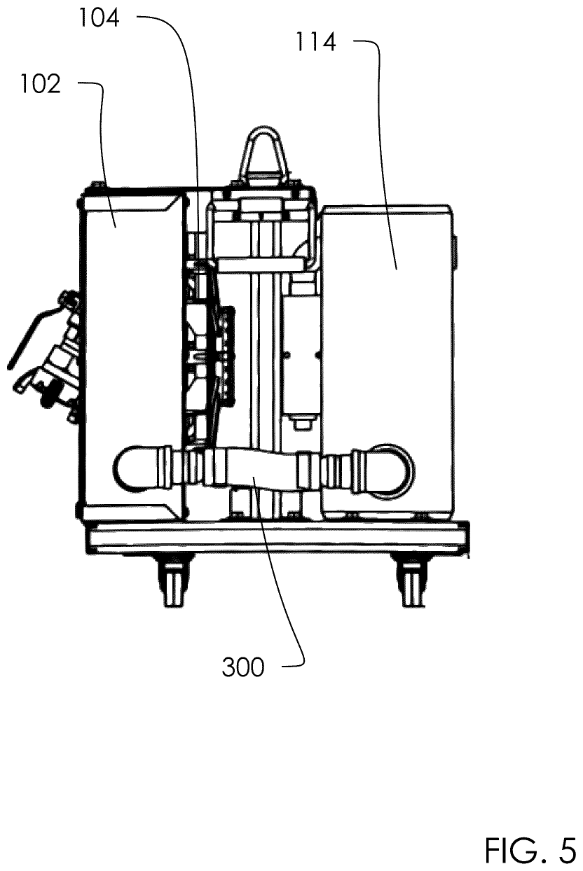

FIG. 5 illustrates an elevated side view of said air cleaner system 100, showing the alignment and interaction of various components like said air dryer assembly 102, said fan 104, and said mini flex assembly 114.

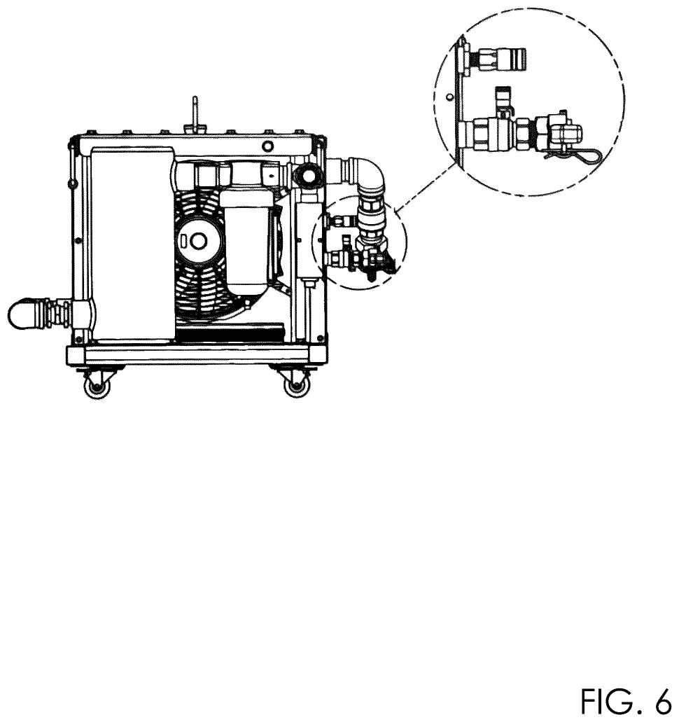

FIG. 6 illustrates an elevated rear view of said air cleaner system 100 with a detailed callout of said air output assembly 118 and said air input assembly 106.

In one embodiment, said air cleaner system 100 interfaces with said target equipment 120 through said air output assembly 118.

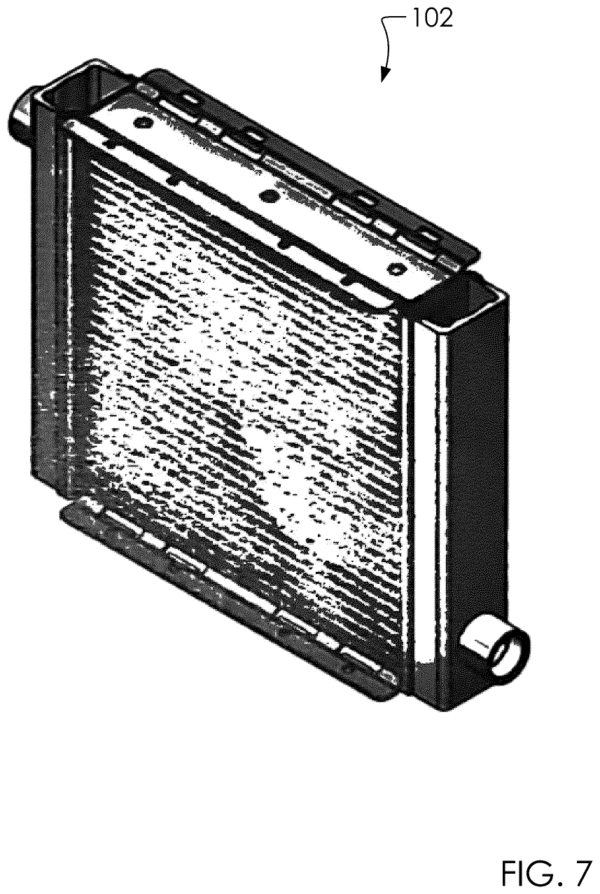

FIG. 7 illustrates a perspective overview of said air dryer assembly 102.

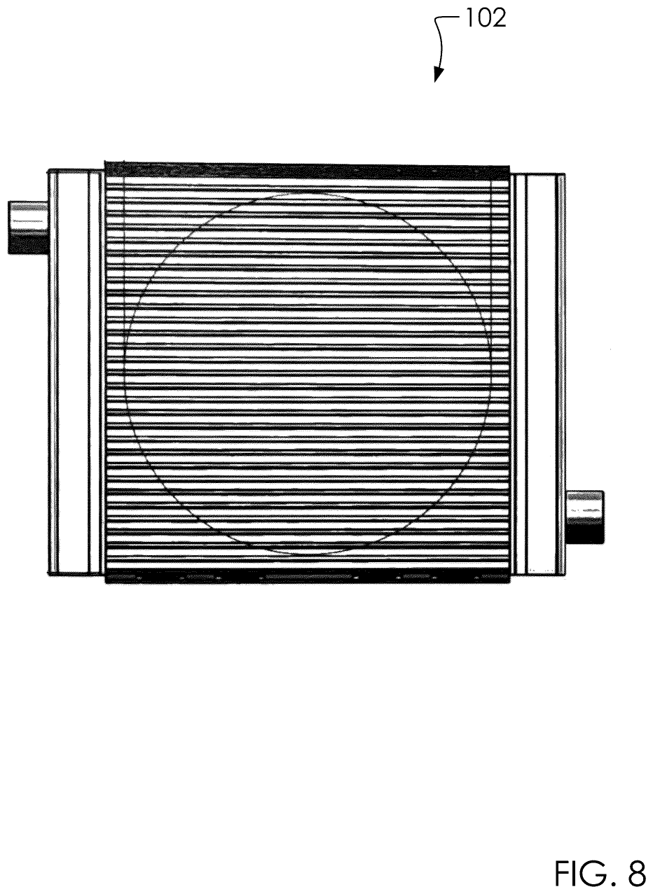

FIG. 8 illustrates an elevated front view of said air dryer assembly 102.

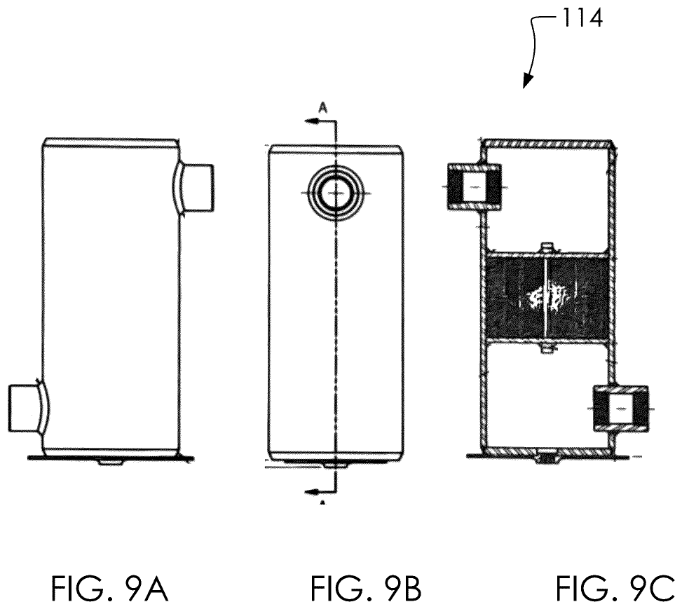

FIGS. 9A, 9B, and 9C illustrate an elevated side view, front view, and cross-sectional side view of said mini flex assembly 114.

In one embodiment, said filter assembly 116 contributes to improving the quality of the treated air output 122. The compressed air initially passes through a moisture separator, which removes the majority of moisture present in the air. The air then moves through a coalescing filter, which agglomerates any remaining fine moisture particles, forming larger droplets that can be easily removed. This dual-stage filtration process ensures that the treated air output 122 is not only dry but also free from contaminants, making it suitable for use with said target equipment 120. The filtration process highlights the system's capability to efficiently manage moisture and impurities without compromising the volume of compressed air.

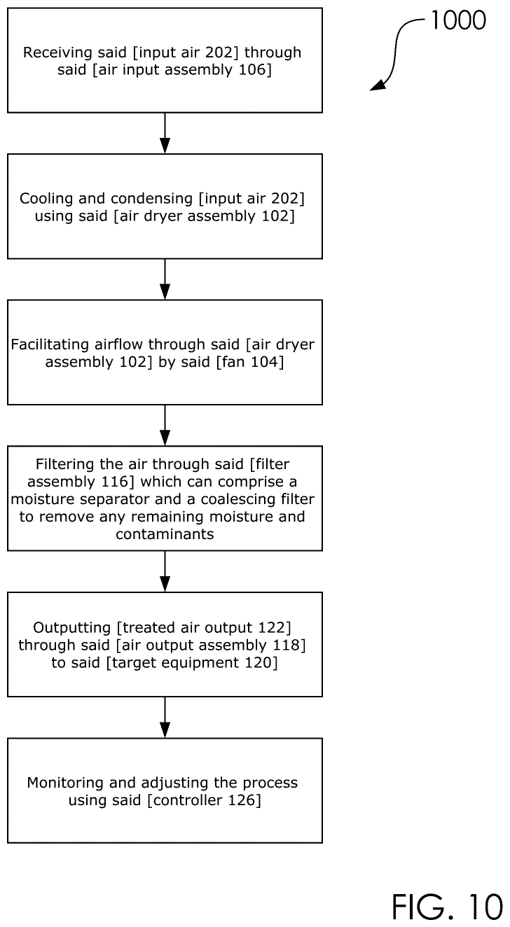

FIG. 10 comprises a method of use 1000 of said air cleaner system 100.

Said method of use 1000 comprises a flow chart, as illustrated.

Said method of use 1000 can comprise: receiving said input air 202 through said air input assembly 106, cooling and condensing input air 202 using said air dryer assembly 102, facilitating airflow through said air dryer assembly 102 by said fan 104, filtering the air through said filter assembly 116 which can comprise a moisture separator and a coalescing filter to remove any remaining moisture and contaminants, outputting treated air output 122 through said air output assembly 118 to said target equipment 120.

In one embodiment, method of use 1000 further comprises monitoring and adjusting the process using said controller 126, to adjust the performance of said air dryer assembly 102 and said fan 104 to ensure optimal treated air quality.

### PARTS LIST

said air cleaner system 100,
said air dryer assembly 102,
said fan 104,
said air input assembly 106,
said power supply 108,
said power switch 110,
said water reservoir 112,
said mini flex assembly 114,
said filter assembly 116,
said air output assembly 118,
said target equipment 120,
said treated air output 122,
said frame assembly 124,
said controller 126,
said block diagram 200,
said input air 202,
said device application 204,
said one or more sensors 206,
said hose assembly 300, and
said method of use 1000.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An air cleaner system for filtering an input air into a treated air output, wherein:
air cleaner system comprises an air input assembly, an air dryer assembly, a fan, a mini flex assembly, a filter assembly and an air output assembly;
a fan configured to facilitate airflow through said air dryer assembly;
a filter assembly is configured to remove contaminants and moisture from said compressed air;
an air input assembly configured to receive said input air; and
an air output assembly configured to provide treated air to a target equipment.

2. The air cleaner system of claim 1, wherein
a filter assembly comprising a moisture separator and a coalescing filter, configured to remove contaminants and moisture from said compressed air.

3. The air cleaner system of claim 1, wherein
said air cleaner system further comprises a controller configured to monitor conditions within said air cleaner system and adjust the performance of said air dryer assembly and said fan.

4. The air cleaner system of claim 1, wherein
said air output assembly further comprises a quick connect system configured to selectively attach and detach from said target equipment.

5. The air cleaner system of claim 1, wherein
said filter assembly further comprises a coal-free filter and an optional lubricant filter, ensuring the air is free from contaminants and moisture.

6. The air cleaner system of claim 1, wherein
said air cleaner system can further comprise device application configured to generate said sensor data of ruse by controller in controlling air cleaner system; and
said controller is further configured to receive sensor data related to airflow, temperature, and moisture levels and to dynamically adjust the operation of said air dryer assembly and said fan based on said sensor data.

7. The air cleaner system of claim 1, wherein
said air cleaner system is cart-mounted allowing for easy maneuverability with handles and caster wheel mounts.

8. The air cleaner system of claim 1, wherein
said air cleaner system further comprises a power supply configured to operate said air cleaner system using either AC power or a 12V battery.

9. The air cleaner system of claim 1, wherein
said power supply is configured to interface with said controller to regulate power distribution among said components, ensuring consistent and reliable operation.

10. The air cleaner system of claim 1, wherein
said air cleaner system is configured to operate in both field environments and stationary locations, providing treated air suitable for applications including paint systems, safety equipment, gas pipeline maintenance, and light-duty sandblasters.

11. The air cleaner system of claim 1, wherein
said air dryer assembly and said fan are arranged to maximize airflow efficiency and cooling capacity.

12. An air cleaner system for filtering an input air into a treated air output, wherein:
said air cleaner system comprises an air input assembly, an air dryer assembly, a fan, a mini flex assembly, a filter assembly and an air output assembly;
a fan configured to facilitate airflow through said air dryer assembly;
a filter assembly is configured to remove contaminants and moisture from said compressed air;
an air input assembly configured to receive said input air;
an air output assembly configured to provide treated air to a target equipment;
said air cleaner system further comprises a controller configured to monitor conditions within said air cleaner system and adjust the performance of said air dryer assembly and said fan;
said air cleaner system can further comprise device application configured to generate said sensor data of ruse by controller in controlling air cleaner system; and
said controller is further configured to receive sensor data related to airflow, temperature, and moisture levels and to dynamically adjust the operation of said air dryer assembly and said fan based on said sensor data.

13. A method of use of an air cleaner system for cleaning compressed air, comprising:
receiving the input air through an air input assembly,
cooling and condensing moisture from said input air using an air dryer assembly,
facilitating airflow through said air dryer assembly using a fan,
passing said compressed air through a filter assembly comprising a moisture separator and a coalescing filter to remove remaining moisture and contaminants,
providing treated air through an air output assembly to a target equipment; wherein,
said air cleaner system comprises the air input assembly, the air dryer assembly, the fan, a mini flex assembly, the filter assembly and the air output assembly;
a fan configured to facilitate airflow through said air dryer assembly;
a filter assembly is configured to remove contaminants and moisture from said compressed air;
an air input assembly configured to receive said input air;
an air output assembly configured to provide treated air to the target equipment.

14. The method of use of claim 13, further comprising:
monitoring and adjusting the performance of said air dryer assembly and said fan using the controller to optimize treated air output.
